(19) United States
(12) Patent Application Publication
(10) Pub. No.: US 2001/0042342 A1
(43) Pub. Date: Nov. 22, 2001

(54) Flowers support system and apparatus

(76) Inventor: Phillip LaMear, Seattle, WA (US)

Correspondence Address: ROBERT B. HUGHES, HUGHES & SCHACHT, P.S., 2801 MERIDIAN STREET, SUITE 1, BELLINGHAM, WA, 98225-2412, US

(21) Appl. No.: 09/834,275

(22) Filed: Apr. 12, 2001

Related U.S. Application Data
(60) Provisional application No. 60/196,680, filed on Apr. 12, 2000.

(51) Int. Cl. B32B 1/02; F16L 1/00; B65D 1/00

(52) U.S. Cl. 47/66.1; 428/34.1

(57) ABSTRACT

A two piece vase adapted to house flowers or a floral arrangement. An insert is adapted to be mounted in a chamber of a vase structure. The insert is not readily visible when inserted into the vase structure and provides a watertight seal. The insert is further easier to clean and provides a more convenient method of mounting the flowers into the vase.

### RELATED APPLICATIONS

This application claims priority of U.S. Provisional Application Ser. No. 60/196,680 filed Apr. 12, 2000.

### BACKGROUND OF THE INVENTION

1. Field of the Invention

The invention relates to vases and devices to display flowers or the like.

Vases or other devices adapted to hold flowers traditionally have sufficient open areas that allow the interior portion to be cleaned by hand. However, with vases having a narrow dimension portion the opening to the interior chamber does not allow easy access to the chamber region for cleaning. Further, when a vase is comprised from heterogeneous materials it is not readily feasible to provide a watertight vase.

Therefore, it is advantageous to have a heterogeneous vase that provides an aesthetically pleasing appearance while providing a waterproof chamber. To maintain a waterproof chamber brings forth numerous challenges with discrete components and especially when the components are of different materials.

The applicant has experimented with sealing the first chamber of the vase using caulking materials and other transparent adhesives; however, the applicant could not provide satisfactory results. Namely, any caulking material or glue would diminish the visible characteristics around the perimeter of the first and second transverse visible portions. Further, given the different characteristics of glass and a stone type material such as marble, it was extremely difficult to provide a first chamber that could hold water even at low head static pressure. Finally, trying to seal the first chamber did not remedy the problems with cleaning the vase.

Therefore, the applicant remedied these problems by retrieving a transparent insert having an upper end that is open and provides access to a second chamber that is watertight. The insert can be placed in the first chamber and is nearly unnoticeable when in an operating position (i.e. with flowers and fluid contained therein).

The insert is much less expensive than the remainder of the vase and in the preferred form is made from a unitary transparent plastic structure. The insert can be machine or hand washed or can be easily replaced. Further, the insert allows the stem portions of the flowers or floral arrangements to be inserted therein and water poured into the chamber of the insert (referred to as the second chamber) and then the insert can be placed into the first chamber of the vase structure.

2. Background Art

A search of the patent literature produced the following applications.

U.S. Pat. No. 5,628,164 & U.S. Pat. No. 5,363,592 Weder et al, shows a flower container and various aspects of a water proof cover.

U.S. Pat. No. 4,525,950 Glassman, shows a receptacle in which an inner container 10, is surrounded by an outer container. The containers are both fluid tight and fluid may be placed in one or in both. The inner container is adapted to hold dried flowers, while the outer volume contains a decorative fluid.

U.S. Pat. No. 4,014,506 Hanson, shows a system in which a smaller flower pot is suspended in a larger container.

U.S. Pat. No. 1,856,179 Wells, shows an ornamental outer container used to house a flower pat containing a plant.

U.S. Pat. No. 1,087,546 Nies, shows a plant container formed of wood, with an outer layer of bark provided with a metal insert for containing a plant.

### SUMMARY OF THE INVENTION

The invention comprises a frame and an insert. The frame consists of at least one transparent portion and has an upper opening that provides access to an inner chamber. The insert has a chamber portion and an upper opening and is adapted to fit within the said chamber of the frame. The insert has a transparent portion that corresponds to the position transparent portion of the frame. The insert is waterproof and adapted to receive flowers and water therein. Further, the insert is replaceable at a lower cost than the frame.

### BRIEF DESCRIPTION OF THE DRAWINGS

FIG. 1 is a perspective view exploded where the insert is shown above the vase structure;

FIG. 2 is a vertical cross-sectional view taken at line 2-2 of FIG. 1 looking down one of the sides of the vase structure with the insert contained therein; and

FIG. 3 is a vertical partial cross-sectional view taken at line 2-2 of FIG. 1 showing a section of the insert and the vase structure.

### DETAILED DESCRIPTION OF PREFERRED EMBODIMENTS OF THE PRESENT INVENTION

An axis system 10 is defined where the axis 12 indicates a lateral direction, the axis 14 indicates a transverse direction and the axis 16 indicates a vertical direction.

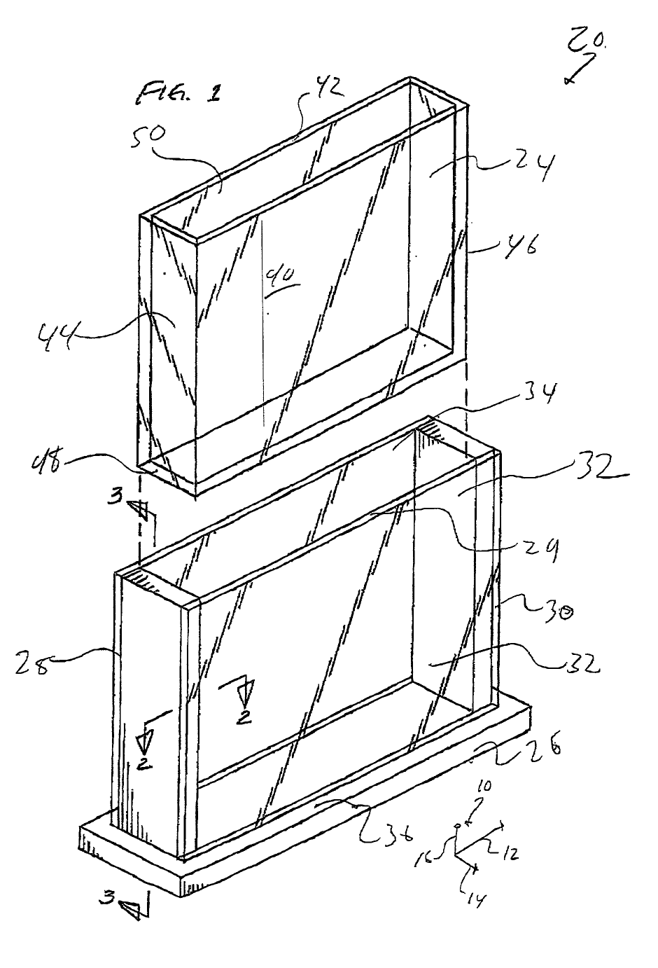

As shown in FIG. 1, the apparatus and 20 comprises a frame 22 and a transparent insert 24. The frame 22 comprises a base portion 26, substantially vertical members 28 and 30, and first and second transparent members 32 and 34. The base portion 26 and the members 28 and 30 are preferably made from a rigid material such as marble or other materials. Such materials include but are not limited to stone type materials, mineral materials, nontransparent marble like stone. It is desirable to have a material with an aesthetically pleasing finish. The base platform 26 has an upper surface 36 that provides support for the members 28 and 30. The members 28 and 30 are substantially vertical and attached to the transparent portions 32 and 34. The material used for the transparent members 32 and 34 is preferably glass; however, other transparent mediums could be used. The inner surface of the transparent members 32 and 34, and the inner surface of the vertical supports 28 and 30 as well as the upper surface of the base 26 define a chamber 27. In the upper portion of the frame 22 there is located the upper opening portion 29.

It should be noted that glass and marble have different thermal coefficients of expansion. This creates a problem for attaching the vertical members 28 and 30 to the glass portions 32 and 34. Of course, the apparatus 20 must be aesthetically pleasing to the end consumer.

The inventor has experimented with numerous glues and adhesives to try to find a working combination to create a sealed vase that can hold water. Due to the different physical properties of glass and marble it was difficult to find an adhesive with adequate results. The glue would either fail in time, due to moisture and/or sunlight, or excessive caulking was required at the contact portions. The excessive amount of adhesive at the contact portions ruined the aesthetics of the vase 20.

The inventor therefore resorted to using double-coated acrylic foam tapes and adhesives transfer tapes. The specific brand used by the inventor is VHB™ (Very High Bond) produced by 3M™ Specialty Tapes & Adhesives. This product discreetly attached the transparent portions 32 and 34 to the vertical members 28 and 30.

However, the problem of having the vases 20 seal water still remained. Further, cleaning the vase was impossible due to the narrow gap between the transparent members 32 and 34.

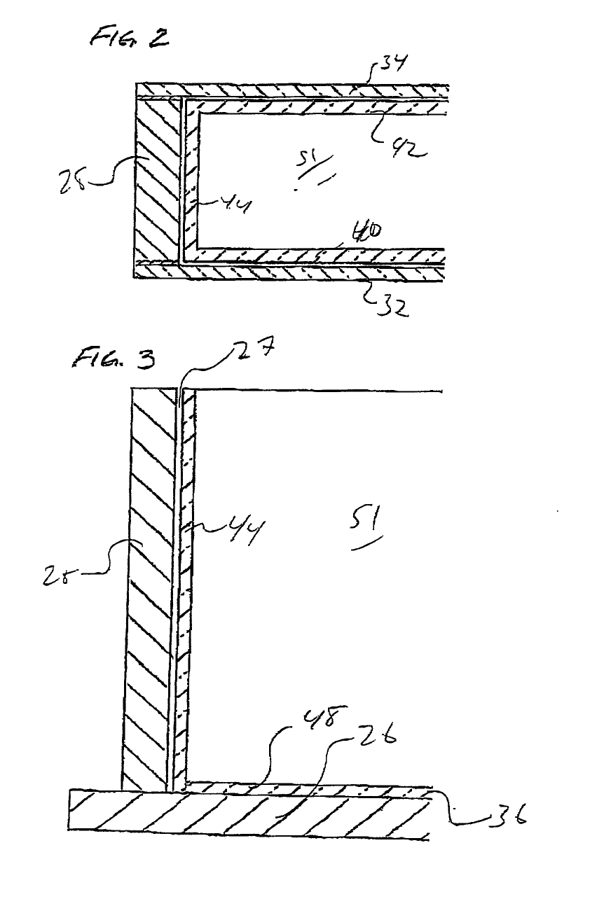

The inventor therefore developed the insert 24. The insert 24 comprises a first transparent wall 40, a second transparent wall 42, side transparent walls 44 and 46, and bottom transparent wall 48. The upper portion of walls 40, 42, 44, and 46, define an opening 50 provides communication to second chamber 51. In operation water is poured into the opening 50 and flowers are inserted therein (see FIG. 3). Then as seen in FIG. 1, the lower wall 40 is inserted into the opening 29 to of the frame member 22. Shown in FIG. 2, the insert is nearly all the way placed in the chamber 27. When the insert is fully inserted the lower surface of the bottom wall 48 is resting upon the upper surface 36 of the base portion 26 (see FIG. 3).

It should be noted that the insert 24 could be plastic injection molded. It should further be noted that the insert 24 is generally less expensive to produce than the frame 22. Therefore, if the insert 24 becomes very dirty (from mildew for example) and impossible to clean, the owner of the apparatus 20 can order a new insert 24.

As shown in the figures, the ratio between the lateral width and the transverse with of the first chamber in the preferred form has a ratio that is greater in the lateral direction then the transverse direction. A broad range for this dimension is 1-1 and providing a square horizontal cross-sectional opening. A more preferred range is 3-1 where the lateral width is at least three times greater than the transverse width and other ranges include at least 5-1 and 8-1. In the preferred form the height of the apparatus 20 is greater than the height as shown in FIG. 1 with respect to the other dimensions.

While the invention is susceptible of various modifications and alternative forms, specific embodiments thereof have been shown by way of example in the drawings and will herein be described in detail. It should be understood, however, that it is not intended to limit the invention to the particular forms disclosed, but, on the contrary, the intention is to cover all modifications, equivalents and alternatives falling within the spirit and scope of the invention as expressed in the appended claims.

I claim:

1. A vase adapted to house flowers or floral arrangements having stem portions, the vase comprising:
a structure having a base portion and an upper portion where the upper portion has a cross-sectional open area allowing passage to a first chamber region,
an insert having an upper open area that provides access to a second chamber region,
whereas, the insert is adapted to be mounted into the first chamber region of the structure and house the stemmed portions of the flowers or floral arrangements therein.

2. The apparatus as recited in claim 1 further comprising:
whereas the insert is adapted to hold water.

3. The apparatus as recited in claim 1 further comprising:
where the vase has a first lateral portion and a second lateral portion comprising first and second substantially vertical members.

4. The apparatus as recited in claim 3 where the first and second substantially vertical members are a nontransparent material.

5. The apparatus as recited in claim 3 where the vase further has first and second transparent portions.

6. The apparatus as recited in claim 5 where the insert is transparent.

7. The apparatus as recited in claim 6 further comprising:
where the stem portions of the flowers or floral arrangements are viewable when the insert is located in the first chamber region.

8. The apparatus as recited in claim 7 where the insert is a plastic injected transparent unitary structure.

9. The apparatus as recited in claim 1 further comprising:
where the structure comprises first and second substantially vertical members and a first and second transparent members.

10. The apparatus as recited in claim 9 further comprising:
where the first and second transparent members are attached to the first and second substantially vertical members using double sided tape.

11. The apparatus as recited in claim 10 further comprising:
where the first and second lateral members and the base region is made from a stone type material.

12. The apparatus as recited in claim 11 further comprising:
where the double sided tape is a product named Very High Bond™.

13. The apparatus as recited in claim 1 where the insert is a plastic injected transparent unitary structure.

14. The apparatus as recited in claim 11 further comprising:
where the insert is a plastic injected transparent unitary structure.

15. The apparatus as recited in claim 1 further comprising:
where the cross-sectional open area of the upper section is rectangular in the horizontal plane.

16. The apparatus as recited in claim 1 where the insert has an outer surface that is proximately located near an inner surface of the first chamber region.

17. The apparatus as recited in claim 16 further comprising:
where the insert is substantially rectangular in each orthogonal view.

18. A method of displaying a floral arrangement comprising the steps of:
retrieving a structure having a base region and an upper open region where the upper open region provides access to a first chamber region,
retrieving and insert having an outer surface and an inner surface defining a second chamber, the upper portion of the insert having an open region that is adapted to house a floral arrangement and fluid therein,
inserting a floral arrangement to the open region of the insert and further placing a fluid therein,
positioning the insert in the first chamber region of the structure.

19. The method as recited in claim 18 where the insert is disposable and a second insert is retrieved and placed in the chamber.

20. The method as recited in claim 18 further comprising:
where the structure comprises first and second substantially vertical members and a first and second transparent members.

21. The method as recited in claim 18 further comprising:
where the first and second transparent members are attached to the first and second substantially vertical members using double sided tape.

22. A vase having a first transverse side and a second transverse side where the first and second transverse sides have lateral regions attached to first and second lateral members, the vase further having base region attached to the first and second lateral members, the first and second transverse sides, the first and second lateral regions, and the base defining a first chamber having an upper open end, an insert having an upper opening and outer dimensions in the transverse and lateral directions whereas the insert is adapted to be housed within the chamber and easily removable therefrom.

23. The apparatus as recited in claim 22 where the lateral dimension of the first chamber is greater than the transverse dimension by a factor of at least 3-1.

24. The apparatus as recited in claim 22 where the lateral dimension of the first chamber is greater than the transverse dimension by a factor of at least 5-1.

25. The apparatus as recited in claim 22 where the outer surface of the insert is in close engagement with the inner surface of the chamber.

26. The apparatus as recited in claim 22 where the insert is adapted to house water when in the upright position.

27. The apparatus as recited in claim 26 where the insert is disposable.

28. The apparatus as recited in claim 22 where the insert is not easily visible when inserted into the chamber and provides a watertight second chamber whereas the first chamber does not hold water or is susceptible to mildew stains.
